(19) United States
(12) Patent Application Publication
(10) Pub. No.: US 2026/0168309 A1
(43) Pub. Date: Jun. 18, 2026

(54) METHODS AND APPARATUS TO DETECT AND RESPOND TO DRIVE BELT FAILURES IN VERTICALLY TRANSLATING DOORS

(71) Applicant: Rite-Hite Holding Corporation, Milwaukee, WI (US)

(72) Inventors: Luke Nuzzo, Platteville, WI (US); Derek Lewan, Hazel Green, WI (US); Steven Hart Campbell, Peosta, IA (US); Connor Kaufmann, Dubuque, IA (US); Thomas Leibfried, Potosi, WI (US); Luke Ryder Kamps, Platteville, WI (US); Michael Sivill, Dubuque, IA (US)

(21) Appl. No.: 19/421,423

(22) Filed: Dec. 16, 2025

Related U.S. Application Data
(60) Provisional application No. 63/734,391, filed on Dec. 16, 2024.

(51) Int. Cl. E05F 15/643; E05F 15/41

(52) U.S. Cl. CPC E05F 15/643; E05F 15/41; E05Y 2201/672

(57) ABSTRACT

Systems, apparatus, articles of manufacture, and methods to detect and respond to drive belt failures in vertically translating doors are disclosed. An example apparatus comprising: a bracket mountable adjacent to a drive belt of a vertically translating door, and a roller to be coupled to the bracket in a position to be in contact with the drive belt. The roller pivots about a first axis relative to the bracket. The roller rotates about a second axis relative to the bracket as the drive belt moves against the roller. The example apparatus further includes a sensor to sense movement of the roller about the first axis in response to a loss of tension in the drive belt.

### RELATED APPLICATION(S)

This patent claims the benefit of U.S. Provisional Ser. No. 63/734,391 , which was filed on Dec. 16, 2024. U.S. Provisional Ser. No. 63/734,391 is hereby incorporated herein by reference in its entirety. Priority to U.S. Provisional Ser. No. 63/734,391 is hereby claimed.

### FIELD OF THE DISCLOSURE

This disclosure relates generally to doors and, more particularly, to methods and apparatus to detect and respond to drive belt failures in vertically translating doors.

### BACKGROUND

A variety of power-operated doors have movable door panels for selectively blocking and unblocking a passageway through a doorway. Many commercial security door panels are made of rigid slats that are lowered and raised along tracks as the door panel moves between open and closed positions.

### BRIEF DESCRIPTION OF THE DRAWINGS

FIG. 1A is a front (e.g., exterior) view of an example door system constructed in accordance with teachings disclosed herein.

FIG. 1B is a rear (e.g., interior) perspective view of portions of an example side frame assembly on a lateral edge of a door panel of the example door system of FIG. 1A.

FIG. 2 is a top, rear, perspective view of the upper portion of the example side frame assembly of FIGS. 1A and 1B.

FIG. 3 a different perspective view of the upper portion of the example side frame assembly of FIG. 2.

FIG. 4 is another different perspective view of the upper portion of the example side frame assembly of FIG. 2.

FIG. 5 is a cutaway perspective view of the upper portion of the example side frame assembly of FIG. 2.

FIG. 6 is a perspective view of the example belt tension sensing assembly of FIGS. 2-5.

FIG. 7 is a front view of the example belt tension sensing assembly of FIGS. 2-5.

FIG. 8 is a top view of the example belt tension sensing assembly of FIGS. 2-5.

FIG. 9 is a side view of the example belt tension sensing assembly of FIGS. 2-5.

FIG. 10A is a perspective view of the example fall protection assembly of FIGS. 2-5 with an example detent in an extended position.

FIG. 10B is a perspective view of the example fall protection assembly of FIGS. 2-5 with the example detent in a retracted position.

FIG. 11 is a front view of the example fall protection assembly of FIGS. 10A and 10B.

FIG. 12 is a top view of the example fall protection assembly of FIGS. 10A and 10B.

FIG. 13 is a side view of the example fall protection assembly of FIGS. 10A and 10B.

FIG. 14A is a cross-sectional view of another example door system with another example fall protection assembly with an example detent in a retracted position.

FIG. 14B is a cross-sectional view of the example door system of FIG. 14A with the example detent in an extended position.

In general, the same reference numbers will be used throughout the drawing(s) and accompanying written description to refer to the same or like parts. The figures are not necessarily to scale.

### DETAILED DESCRIPTION

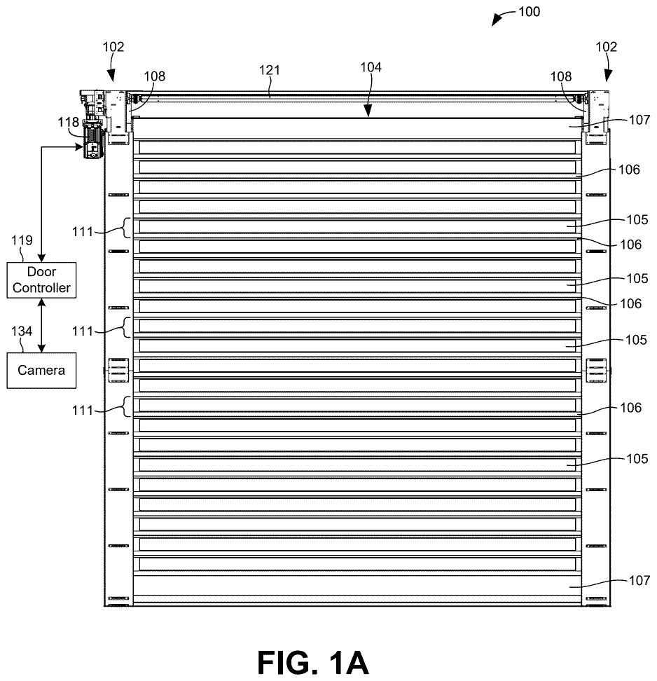

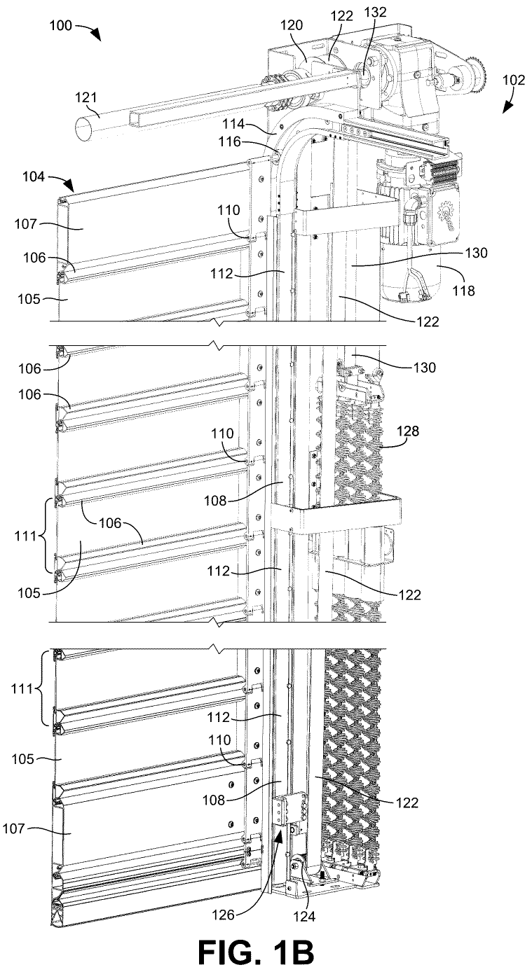

FIG. 1A is a front (e.g., exterior) view of an example door system 100 constructed in accordance with teachings disclosed herein. FIG. 1B is a rear (e.g., interior) perspective view of portions of an example side frame assembly 102 on lateral edge of a door panel 104 (also referred to herein simply as a door for short) of the example door system 100 of FIG. 1A. In some examples, a similar side frame assembly 102 can be implemented on the opposite lateral edge of the door panel 104. In both FIGS. 1A and 1B, the door panel 104 is in a closed position to block passage through an associated doorway.

The example door system 100 of FIGS. 1A and 1B is a security door system in which the door panel 104 is made of a plurality of panel segments (also referred to herein simply as panels for short). In some examples, the panel segments can be solid panels 107 or vision panels 111. In the illustrated example, the solid panels 107 are defined by a solid piece of extruded metal (e.g., aluminum). By contrast, the vision panels are defined by a panel insert 105 secured between two opposing support beams 106 that extend between tracks 108 of the side frame assemblies 102. In some examples, the support beams 106 of a vision panel 111 are made of metal (e.g., extruded aluminum) to provide rigidity and structural integrity to the panel. In some examples, the panel inserts 105 of vision panels 111 are also made of metal (e.g., metal sheets) that include perforations or other openings to permit a person to see through the panel 111 when the door panel 104 is closed. Additionally or alternatively, in other examples, one or more of the panel inserts 105 is made of a transparent material (e.g., a plastic sheet) to permit a person to see through the door panel 104 when it is closed. Additionally or alternatively, in some examples, one or more of the panel inserts 105 is made of a semi-transparent and/or translucent material (e.g., a plastic sheet that is tinted and/or has a frosted surface). In some examples, one or more of the panel inserts 105 are omitted. In the illustrated example, the door panel 104 includes a solid panel 107 adjacent the top and bottom ends (e.g., the leading and trailing edges) of the door panel 104 with all other panel segments along the height of the door panel 104 being vision panels 111. In other examples, one or more of the vision panels 111 can be replaced with solid panels 107. In some examples, all panel segments of the full door panel 104 are implemented by solid panels 107.

Although the example door system 100 of FIGS. 1A and 1B is described as a security door system with solid panels 107 made of metal and/or vision panels 111 made of metal support beams 106 with intervening panel inserts 105 (which may be made of metal or plastic) defining different segments of the door panel 104, other types of door systems and/or other materials for the door panel 104 can be used instead. For instance, in some examples, the solid metal panels 107 and/or the support beams 106 are a material other than metal. In some examples, the panel segments (e.g., the solid panels 107 and/or the vision panels 111) are replaced by a metal grate. In some examples, the door panel 104 is made of a flexible material (e.g., a fabric) rather than rigid panel segments 107, 111.

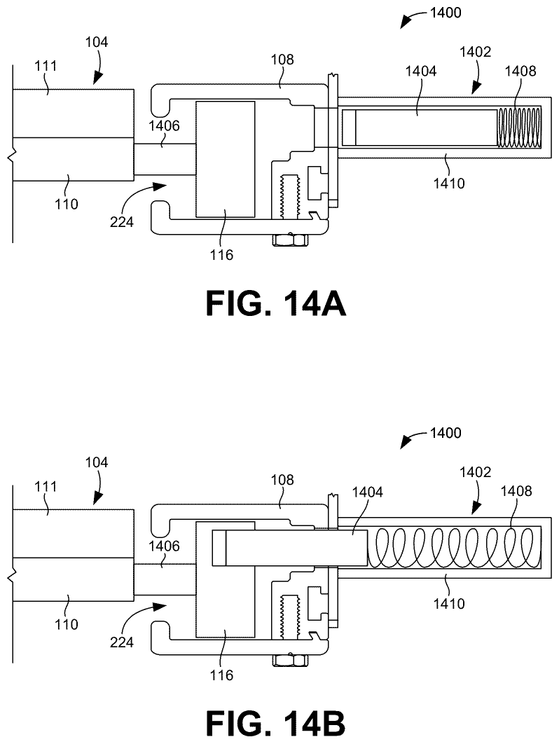

As shown in the illustrated example, adjacent ones of the panel segments (e.g., the solid panels 107 and the vision panels 111) are interconnected via hinges 110 that enable each panel 107, 111 to rotate relative to one another, thereby permitting the overall door panel 104 to bend and follow curves in the tracks 108. More particularly, in some examples, the tracks 108 include at least one straight portion 112 and at least one curved portion 114. In some examples, the at least one straight portion 112 of the tracks 108 extend all or substantially all of the vertical height of a doorway to be blocked by the door panel 104 in the closed position. The curved portion 114 is at the top (e.g., above) the straight portion and directs the door panel 104 to an open position when the door panel 104 is stowed away to unblock the doorway. In some examples, the stowed position (e.g., the open position) of the door panel 104 is associated with a spiral portion of the tracks 108 that enables the door panel 104 rollup on itself in a confined space. In other examples, the stowed position of the door panel 104 is associated with another straight portion of the tracks 108 that extends substantially horizontally overhead. In other examples, the tracks 108 associated with the stowed position of the door panel 104 can have any other suitable shape and/or define any other suitable path that extends in any suitable direction. In some examples, the door panel 104 is guided along the tracks 108 by wheels 116 (e.g., roller) disposed within the tracks 108. In some examples, the wheels 116 are attached to the lateral edges of the door panel 104 via wheel posts aligned with the hinges 110 (as shown in further detail in the illustrated example of FIGS. 14A and 14B discussed further below).

In some examples, at least one side frame assemblies 102 includes a motor 118 that causes a drive wheel 120 (e.g., a roller) associated with each side frame assembly 102 to rotate. In some examples, operation of the motor 118 (e.g., the speed and/or direction of rotation) is controlled and/or directed by a door controller 119 operatively coupled thereto. Although there is only one motor 118 on one side of the door in the illustrated example, the motor 118 is able to drive both drive wheels 120 (associated with respective ones of the side frame assemblies 102) on either side of the door based on a shaft 121 extending between the drive wheels 120 (e.g., extending the full width of the door panel 104). In this example, rotation of the drive wheels 120 cause corresponding drive belts 122 (e.g., timing belts) coupled to the drive wheels 120 to move. As shown in the illustrated example of FIG. 1B, the drive belt 122 extends substantially a full height of the door panel 104 to a tension roller 124 near the bottom of the associated side frame assembly 102. In some examples, a brace assembly 126 couples the door panel 104 to the drive belt 122. More particularly, as shown in the illustrated example of FIG. 1B, the brace assembly 126 is attached to bottom solid panel 107 at or near a bottom edge (e.g., leading edge) of the door panel 104. In some examples, the brace assembly 126 (on each side of the door panel 104) is the only connection between the door panel 104 and the drive belts 122. Due to the connection between the door panel 104 and the drive belts 122, as the drive belts 122 move (based on rotation of the associated drive wheels 120 driven by the motor 118), the door panel 104 also moves. Thus, the motor 118 is able to drive movement of the door panel 104 along the tracks 108 by moving the drive belt 122 in each side frame assembly 102 via the corresponding drive wheel 120.

Inasmuch as the example door panel 104 of FIGS. 1A and 1B is made of metal, the door panel 104 can be relatively heavy. Accordingly, in some examples, to reduce the load on the motor 118, the side frame assembly 102 includes one or more extension springs 128 that extend and contract along the tracks 108 as the door panel 104 moves to provide a counter force to the weight of the door panel 104. In some examples, the extension spring(s) 128 are stretched or contracted as a strap 130 (e.g., a belt, a chain, or other elongate member) coupled to an upper end of the spring(s) 128 winds and unwinds around a drive shaft 132. In some examples, the drive shaft 132 corresponds to (e.g., is an integral extension of) the shaft 121 that extends between the drive wheels 120 on either side of the doorway as shown in FIG. 1. In other examples, the drive shaft 132 is distinct from but rotationally coupled to the shaft 121 that extends across the doorway.

While the extension spring(s) 128 provide a counter force to the weight of the door panel 104, such force will have no ability to hold up the door panel 104 if the drive belt comes loose, breaks, or otherwise fails because the door panel 104 is operatively coupled to the extension spring(s) 128 by way of the drive belt 122. In such scenarios, the door panel 104 may come crashing down, thereby damaging the door and/or posing a risk of harm to people that may be underneath the door. Examples disclosed herein provide example mechanisms (e.g., sensors and/or sensor assemblies) to detect a potential failure of the drive belt 122. More particularly, in some examples, one or more sensors are provided to monitor the tension of the drive belt 122 and provide resulting sensor feedback data to the door controller 119. Based on such sensor data, the example door controller 119 can identify when the drive belt 122 is beginning to fail (e.g., based on a detected loosening of the belt tension) and/or when the drive belt 122 has completely failed (e.g., a loss of all tension due to the belt breaking), Further, examples disclosed herein provide example mechanisms (e.g., fall protection assemblies and/or door locking assemblies) to prevent the door panel 104 from falling in response to the detection of a potential failure of the drive belt 122. More particularly, in some examples, the controller 119 activates an example fall protection assembly that catches the door panel in response to a detected failure of the drive belt 122. In some examples, the fall protection assembly includes extending a mechanical stop or detent into one or both tracks 108 to catch the door panel 104 and prevent it from moving along the tracks 108 and/or falling under its own weight. In some examples, the controller 119 can activate such mechanisms at other times to lock or prevent movement of the door panel 104 (even if there is no failure of the drive belt 122).

In some examples, the door system 100 includes one or more cameras 134 communicatively coupled to the door controller 119. In some examples, the camera 134 is a video camera that is pointed towards the door system 100 to capture video of the operation of the example door system 100. In other examples, the camera 134 is a photography camera that captures still images of the example door system 100. In some examples, the camera 134 captures an entirety of the example door system 100 (e.g., the entire door panel 104 is within the field of view of the camera 134). In other examples, the camera 134 captures only a portion of the door system (e.g., the field of view of the camera captures part of the door panel 104, the operation of the motor 118 and/or other components in the vicinity of the motor 118, the operation of a sensor assembly, and/or the operation of a fall protection assembly, etc.).

In some examples, the door controller 119 initiates a camera capture routine in response to an event (e.g., a belt failure) being detected. In some examples, the camera capture routine involves the camera 134 capturing and storing (e.g., in memory associated with the controller 119) video and/or images of the door system 100 at the time of the detected event. In some examples, the video or images can correspond to a period of time both before and after the event. For instance, in some examples, the door controller 119 may direct the identification of 1 minute of footage that is centered at the time that an event was first detected with 30 seconds of footage included prior to the event and 30 seconds of footage after detection of the event. Accordingly, in some examples, the camera 134 captures video and/or still images on an ongoing basis with the captured content (e.g., a video stream or stream of successive still images) being stored into memory whether or not an event has been detected. In some examples, the memory is a circular buffer that stores the captured content on a rolling basis for a most recent window of time (e.g., the most recent 5 minutes, the most recent 10 minutes, most recent 30 minutes, most recent hour, etc.). In this manner, when the controller 119 detects an event, the captured video and/or images can be retrieved corresponding to the time surrounding the occurrence of the event (e.g., both before and after) to enable a user to review what happened during the event and what led up to the event. In some examples, such event footage is separately stored in memory for later review before it is written over by the ongoing video and/or image capturing of the camera 134. In some examples, the event footage can be made available to a user on a graphical user interface associated with the door controller 119 (e.g., via a display screen of the controller 119). Additionally or alternatively, in some examples, the door controller 119 transmits the event footage to a remote server for subsequent review and/or retrieval by a user.

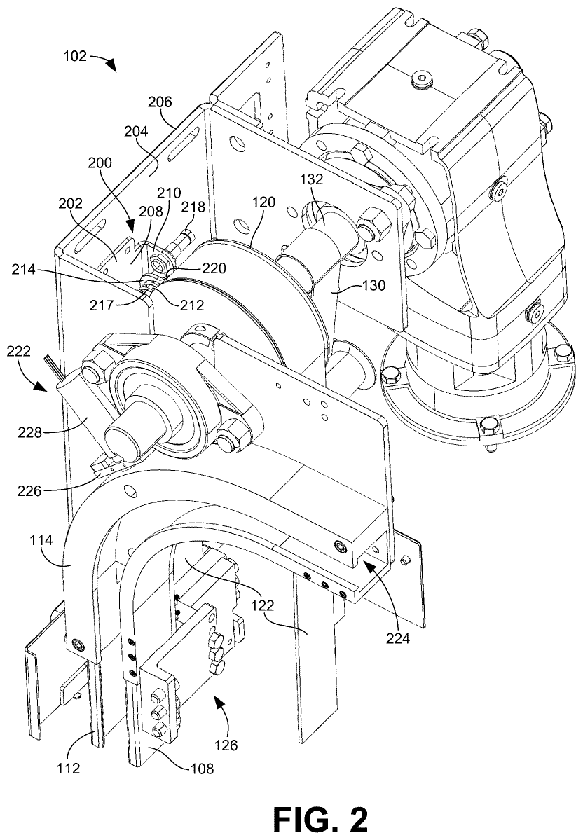

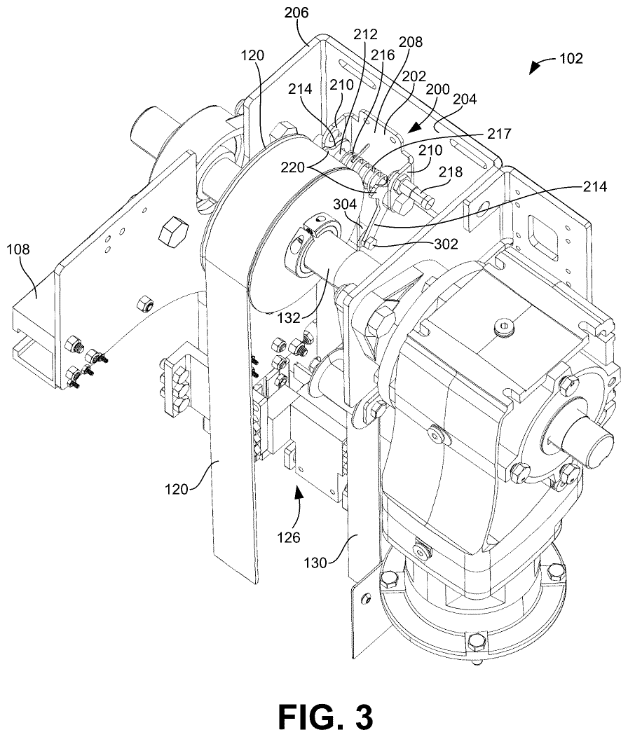

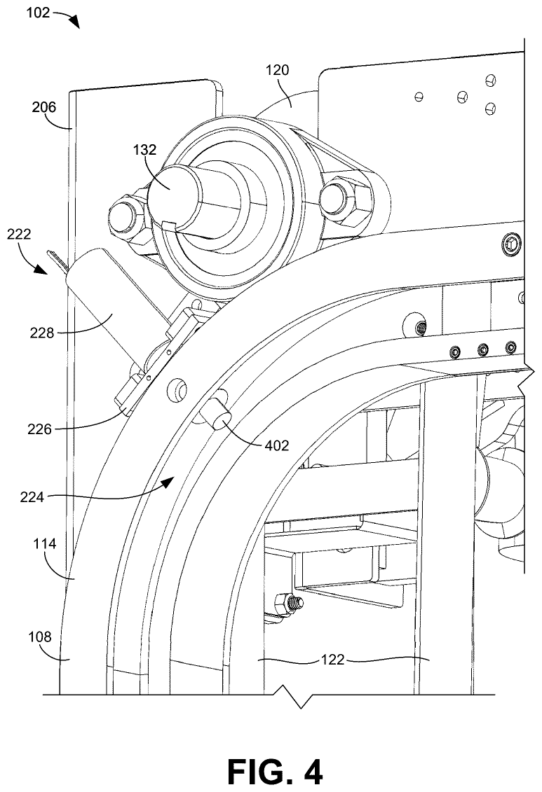

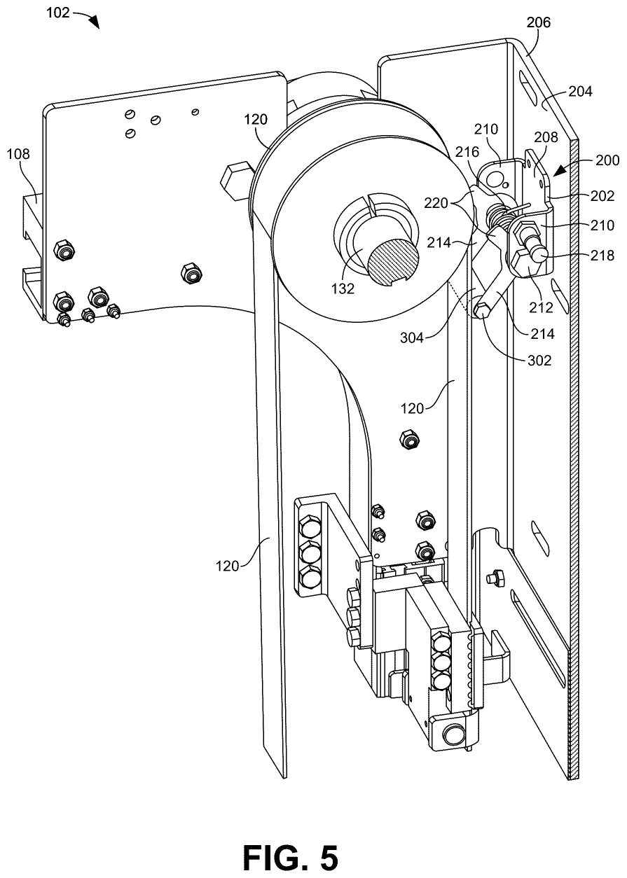

FIG. 2 is a top, rear, perspective view of the upper portion of the side frame assembly 102 of FIGS. 1A and 1B. FIG. 3 a different perspective view of the upper portion of the side frame assembly 102 of FIG. 2. FIG. 4 is another different perspective view of the upper portion of the side frame assembly 102 of FIG. 2. FIG. 5 is a cutaway perspective view of the upper portion of the side frame assembly 102 of FIG. 2. The same reference numbers used in FIGS. 1A and 1B are used for the same features shown in FIGS. 2-5 and the description of such features provided above applies similarly. For purposes of illustration, the door panel 104 and the motor 118 are omitted in FIGS. 2-5. However, as shown, the brace assembly 126 is shown raised up adjacent to the drive wheel 120 at or near the top of the straight portion 112 of the track 108. Thus, if the door panel 104 were shown in FIGS. 2-5, the door panel 104 would be close to a fully open position.

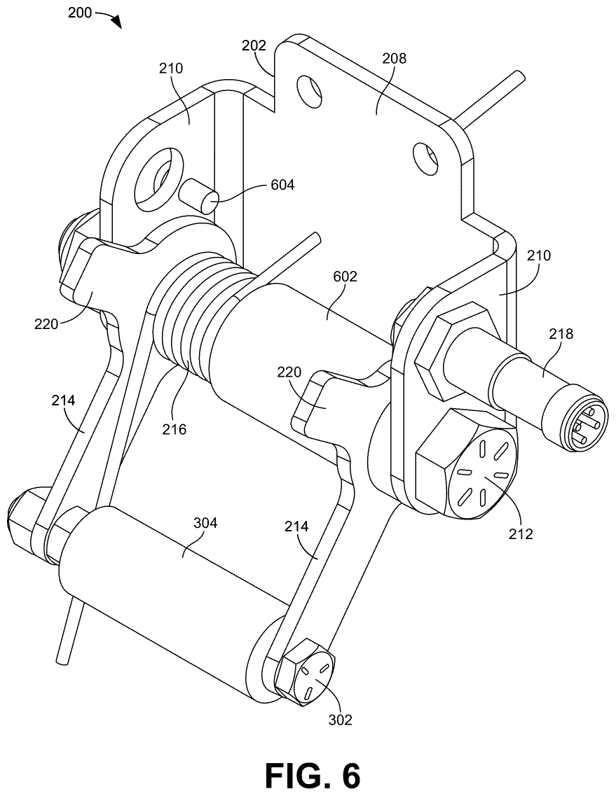

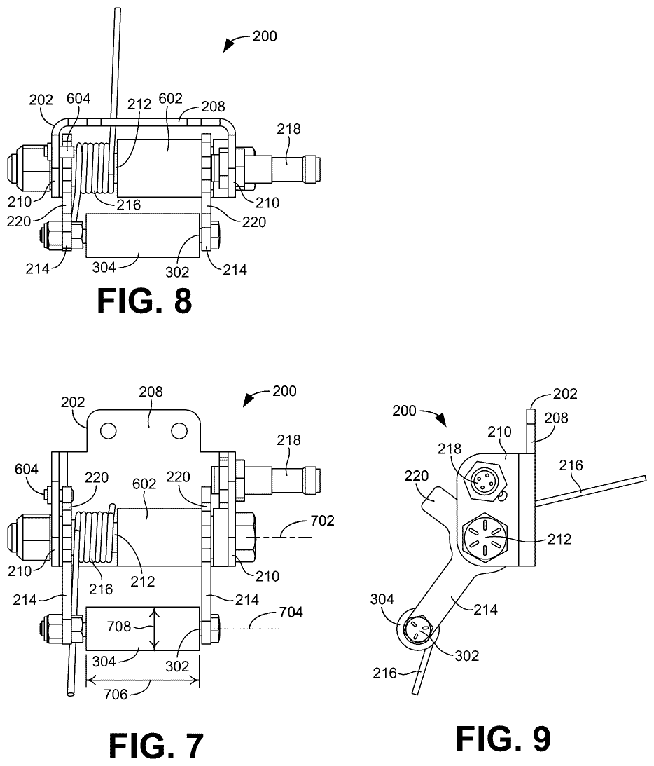

As shown in the illustrated example of FIGS. 2, 3, and 5, an example belt tension sensing assembly 200 is positioned adjacent to the drive wheel 120. Enlarged views of the belt tension sensing assembly 200 are shown in FIGS. 6-9. Specifically, FIG. 6 is a perspective view of the example belt tension sensing assembly 200, FIG. 7 is a front view of the example belt tension sensing assembly 200, FIG. 8 is a top view of the example belt tension sensing assembly 200, and FIG. 9 is a side view of the example belt tension sensing assembly 200. Reference is made to FIGS. 6-9 in conjunction with the description of the example belt tension sensing assembly 200 shown in FIGS. 2, 3, and 5.

In some examples, the belt tension sensing assembly 200 includes a bracket 202 that is mounted (e.g., via threaded fasteners such as screws or bolts) to a wall 204 of a housing 206 of the drive wheel 120. In this example, the bracket 202 is made of a sheet of metal that has been bent into a general C-shape with a backplate 208 (positioned adjacent the wall 204 of the housing 206) and two side flanges 210. The metal material for the bracket 202 provides strength and durability for the belt tension sensing assembly 200. However, in some examples, the bracket 202 can be made of any other suitable material and/or have any other suitable shape. In some examples, a first pin 212 (e.g., bolt, shaft, rod, etc.) extends between the two side flanges 210 to define a first axis or rotation 702 (shown in FIG. 7). In this example, the first axis or rotation 702 defines a pivot axis about which two arms 214 of the assembly 200 are able to rotate. In some examples, the two arms 214 rotate relative to the first pin 212 that is rigidly affixed to the bracket 202. In other examples, the two arms 214 are rigidly affixed to the first pin 212 that rotates (with the arms 214) relative to the bracket 202.

In this example, each of the two arms 214 are cut out (e.g., laser cut, stamped, etc.) from a sheet of metal. However, the arms 214 can be made from any other suitable material. In some examples, the two arms 214 can be integrally formed (e.g., parts of another C-shaped metal sheet). As shown in the illustrated example, each of the two arms 214 are positioned proximate respective ones of the two side flanges 210. In this example, the arms 214 are between the flanges 210. However, in other examples, one or both of the flanges 210 can be between the arms 214. In some examples, each arm 214 is rotatably coupled adjacent to the corresponding flange 210 via a separate pin. In some examples, the belt tension sensing assembly 200 includes only one arm 214. In other examples, the belt tension sensing assembly 200 includes more than two arms 214.

In some examples, the arms 214 support a second pin 302 (e.g., bolt, shaft, rod, etc.) extending therebetween that is spaced away from the first pin 212 (e.g., the second pin 302 is near distal ends of the arms 214). The second pin 302 defines a second axis or rotation 704 (shown in FIG. 7). In some examples, the second pin 302 is substantially parallel (e.g., within five degrees of exactly parallel) to the first pin 212. Thus, in some examples, the second axis of rotation 704 is substantially parallel to the first axis of rotation 702.

As shown in the illustrated example, a roller 304 is positioned between the arms 214 around the second pin 302 extending therebetween. In some examples, the roller 304 is elongate along the axis of rotation (e.g., the second axis of rotation 704). That is, in some examples, the roller has a length 706 that is greater than its width 708 (e.g., diameter). In some examples, the length 706 is at least twice the width 708 of the roller 304. In other examples, the length 706 of the roller 304 is less than or equal to the width 708 of the roller 304.

In some examples, the roller 304 is able to freely rotate about the second pin 302 (e.g., about the second axis of rotation 704). Furthermore, inasmuch as the roller 304 is coupled to the arms that rotate about the first pin 212, the roller is also able to rotate (e.g., pivot) about the first pin 212 (e.g., about the first axis of rotation 702). In some examples, the roller 304 is omitted and/or integrally formed with the second pin 302 and the second pin 302 is able to rotate relative to the arms 214.

In some examples, the belt tension sensing assembly 200 includes a spring 216 (e.g., a torsional spring) that is coiled around the first pin 212 and adjacent one of the arms 214 (as shown in FIG. 3). In some examples, a separate compression spring 217 extends from the spring 216 towards the opposing arm 214 to assist in maintaining the spring 216 in position along the longitudinal length of the first pin 212. In other examples, as represented in FIGS. 6-8, the compression spring 217 is omitted and a bushing 602 (e.g., a spacer) is used instead. In some examples, a first end of the spring 216 is coupled to and/or extends through the backplate 208 of the bracket 202. In FIGS. 6, 8, and 9, the first end of the spring 216 is shown protruding away from the backside of the backplate 208. However, in some examples, when the belt tension sensing assembly 200 is mounted to the housing 206 (as shown in FIGS. 2, 3, and 5), the first end of the spring 216 is bent downwards to rest against the backplate 208 of the bracket 202 and/or the wall 204 of the housing 206 below a bottom edge of the backplate.

In some examples, as shown in FIGS. 6-9, a second end of the spring 216 extends toward and interfaces with at least one of distal ends of one of the arms 214, the second pin 302, or the roller 304. More particularly, in some examples, as shown most clearly in FIG. 6, the second end of the spring 216 extends underneath the second pin 302. Further, in some examples, the spring 216 is preloaded so as to push or urge the second pin 302 (and the associated roller 304 and arms 214) to pivot about the first axis of rotation 702 defined by the first pin 212. However, the pivoting of the second pin 302 (and the associated roller 304 and arms 214) is prevented based on the position of the belt tension sensing assembly 200 relative to the drive belt 122. That is, as shown in the illustrated example of FIG. 3 and more clearly in FIG. 5, the spring 216 causes the roller 304 to be urged towards and into contact with the drive belt 122 (as represented by the dashed lines for the roller 304 that extend into the drive belt 122). When the drive belt 122 is properly tensioned, the roller 304 will press against the drive belt 122, thereby preventing the arms 214 and roller 304 to rotate upwards. However, if the drive belt 122 becomes loose or breaks entirely, there will no longer be tension to counteract the torsional force of the spring 216 acting on the second pin 302 (and the associated roller 304 and arms 214). As a result, the second pin 302, the arms 214, and the roller 304 will rotate or pivot upwards when there is a failure in the drive belt 122.

In some examples, the belt tension sensing assembly 200 includes a sensor 218 to sense and/or detect when the arms 214 pivot about the first axis of rotation 702 defined by the first pin 212. In this example, the sensor 218 is a proximity sensor. More particularly, in some examples, the sensor 218 is mounted on one of the flanges 210 of the bracket 202 to detect the arm 214 adjacent the corresponding flange 210. In some examples, the arm 214 includes a tab 220 protruding from a side of the arm 214 that can move into proximity of the sensor 218 to enable detection of movement of the arm 214 without the need for significant rotation of the arm 214. In some examples, as shown in FIGS. 6-8, the belt tension sensing assembly 200 includes a stop 604 that extends into the rotational path of one of the tabs 220 of one of the arms 214 to prevent rotation of the tabs 220 beyond the location of the sensor 218. Thus, in some examples, during normal operation (e.g., when the drive belt 122 is in tension and not failing), the arms 214 and roller 304 are in a first position with the roller 304 urged against the drive belt 122. However, if the belt becomes loose, breaks, or otherwise fails, the spring 216 urges the arms 214 and roller 304 towards a second position in which the arms 214 (e.g., the tabs 220 on the arms 214) are urged against the stop 604. In the illustrated example of FIGS. 6-8, the stop 604 is on the opposite flange 210 to the flange 210 where the sensor 218 is mounted. However, in other examples, the stop 604 and the sensor 218 can be on the same flange 210. Further, in some examples, a second stop 604 can be on the flange 210 where the sensor 218 is mounted. In other examples, the stop 604 is omitted. In some such examples, the arms 214 and the roller 304 rotate until they either contact the drive wheel 120 or the backplate 208 of the bracket 202.

In some examples, the size, shape, and/or placement of tabs 220 on the arms 214 can differ from what is shown in the illustrated examples to cause the sensor 218 to be triggered based on different extents of rotation of the arm 214 relative to what is represented in the figures. Further, although both of the arms 214 are shown as having the same shape, in some examples, each arm 214 has a different shape (e.g., with different tabs having different sizes, shapes, and/or locations). In some examples, more than one sensor 218 is used (either on the same flange 210 to detect the same arm 214 at different rotational extents or on separate flanges 210 to detect the rotation of the different arms 214). In some examples, different sensors 218 are used to detect different amounts of loss of tension in the drive belt 122. For example, a first loss of tension corresponds to the belt 122 becoming loose without breaking and a second loss of tension corresponds to the belt 122 breaking (e.g., the second loss of tension includes the tension being reduced to zero). In some examples, the tabs 220 are omitted on one or both of the arms 214.

While the foregoing discussion has been provided primarily in the context of the sensor 218 being a proximity sensor, other types of sensors may additionally or alternatively be used. For instance, in some examples, the sensor 218 is a photoelectric sensor that emits a beam of light that extends between the two flanges 210 of the bracket 202. When the arm rotates in response to a loosening of tension in the drive belt 122, the tab 220 will cross the path of the beam of light, thereby triggering a signal from the sensor 218 to the controller 119. In some such examples, the sensor 218 is a through-beam photoelectric sensor with a light emitting portion coupled to one of the flanges 210 and a light receiving portion coupled to the other flange 210. In other examples, the sensor is a retro-reflective photoelectric sensor in which the light emitter and receiver are adjacent one another and carried by the same flange 210 with the beam of light bouncing off a reflective surface of the other flange 210 (or a reflective surface attached to the flange 210). In other examples, the sensor 218 is implemented by an encoder that measure any change in rotation of the arm 214 about the first axis or rotation 702 extending between the flanges 210. In some such examples, the encoder is mounted in alignment with the first axis of rotation 702 (e.g., adjacent an end of the pin 212). In other examples, the encoder is offset relative to first axis of rotation 702 (e.g., at the location of the sensor 218 or any other suitable location) and rotationally coupled to the pin 212 via a chain or sprocket assembly.

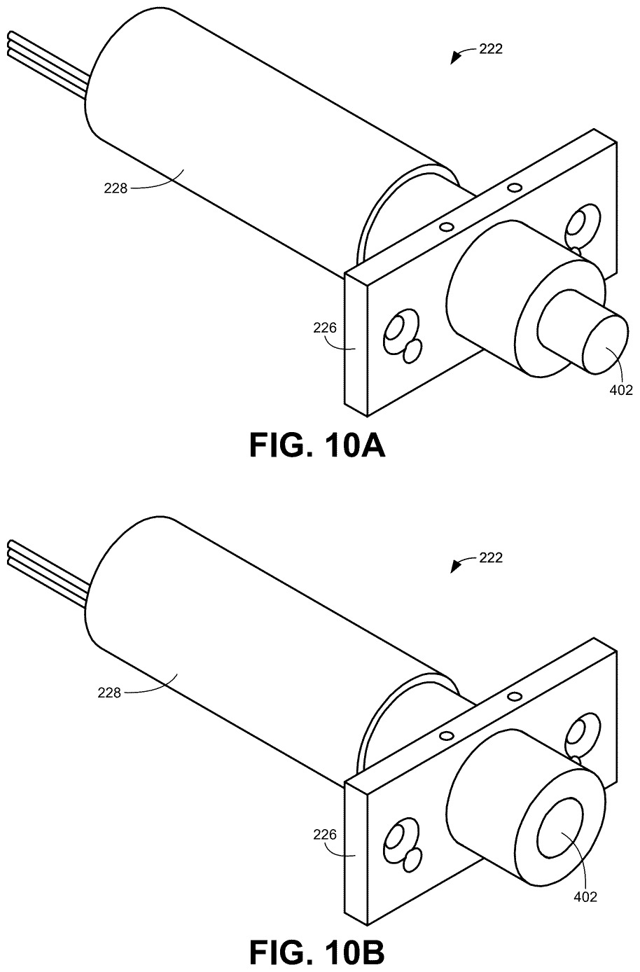

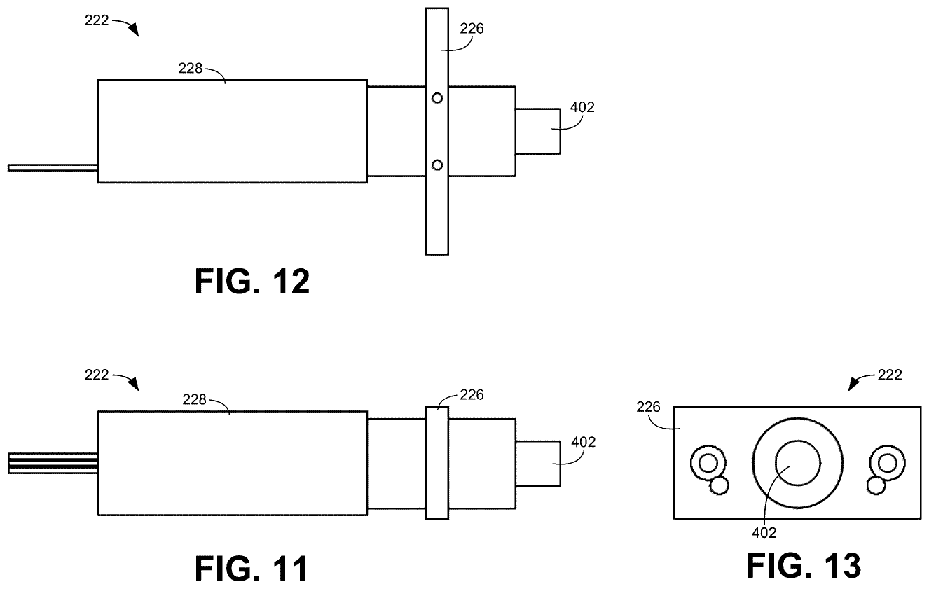

In some examples, as shown in FIGS. 2 and 4, an example fall protection assembly 222 (e.g., a door locking assembly) is positioned adjacent to the track 108. Enlarged views of the fall protection assembly 222 are shown in FIGS. 10A-13. Specifically, FIG. 10A is a perspective view of the example fall protection assembly 222 with an example detent 402 (e.g., mechanical stop) in an extended position, FIG. 10B is a perspective view of the example fall protection assembly 222 with the example detent 402 in a retracted position, FIG. 11 is a front view of the example fall protection assembly 222, FIG. 12 is a top view of the example fall protection assembly 222, and FIG. 13 is a side view of the example fall protection assembly 222. Reference is made to these figures in conjunction with the description of the example fall protection assembly 222 shown in FIGS. 2 and 4.

As shown in the illustrated example of FIG. 4, the fall protection assembly 222 is positioned adjacent to the track 108 so that the detent 402 extends into an inner channel 224 of the track 108 when the detent 402 is in the extended position. More particularly, the detent 402 extends into the track 108 to a sufficient extent to prevent (e.g., block) the wheels 116 coupled to the door panel 104 (as shown in FIG. 1) from being able to travel along the track 108. Thus, the detent 402 is a mechanical stop or catch that prevents movement of the door panel 104. However, in some examples, the detent 402 is substantially or completely removed from the inner channel 224 of the track 108 when the detent 402 is in the retracted position to provide an unobstructed path for the wheels 116 along the inner channel 224 of the track. In some examples, when the detent 402 is in the extended position, the detent 402 extends at least 15% through the inner channel 224. In other examples, the detent 402 extends any other suitable distance through the inner channel 224 (e.g., at least 25%, at least 50%, at least 75%, all the way through the channel 224). In some examples, the detent 402 extends more than the full distance across the inner channel 224 and into or through a hole in an opposite wall of the track 108. Additionally or alternatively, in some examples, the detent 402 extends into a hole within or otherwise interfaces with the door panel 104 (e.g., one of the solid panels 107 and/or vision panels 111).

In the illustrated example of FIGS. 2 and 4, the fall protection assembly 222 is positioned adjacent the curved portion 114 of the track 108. However, in other examples, the fall protection assembly 222 can be adjacent any other suitable location of the track 108 (e.g., the straight portion 112, further up the track 108 beyond the curved portion 114, etc.). In some examples, multiple fall protection assemblies 222 can be positioned at different points along the length of the track 108. In some examples, the fall protection assembly 222 is attached to the track 108 using threaded fasteners (e.g., bolts, screws, etc.) extending through holes in an associated mounting plate 226.

In some examples, the extendible detent 402 extends and retracts from within a housing 228 in a direction substantially normal to the track 108 (e.g., substantially perpendicular to a tangent of the curved portion 114). In the example shown in FIGS. 2 and 4, the fall protection assembly 222 is on the convex side of the curved portion 114. In other examples, the fall protection assembly 222 is on the concave side of the curved portion 114. In other examples, the fall protection assembly 222 is positioned so that the detent 402 extends into the track 108 via a lateral sidewall of the track 108 that is opposite the opening of the track facing towards the door panel 104.

In some examples, the fall protection assembly 222 is a linear solenoid. That is, in some examples, the detent 402 operates as an armature of a linear solenoid that is moved in response to an electrical signal. In some examples, the belt tension sensing assembly 200 is directly wired to the fall protection assembly 222 so that the fall protection assembly 222 automatically actuates the detent 402 to extend in response to the belt tension sensing assembly 200 detecting a failure in the drive belt 122. In other examples, a signal from the belt tension sensing assembly 200 indicating a belt failure is provided to the door controller 119 and the controller 119 then provides a command signal to the fall protection assembly 222. In some examples, the door controller 119 timestamps and records a belt failure detection event and/or transmits a report of the failure detection event to a remote server for archival purposes. Additionally or alternatively, in some examples, the door controller 119 causes a notification to be sent to a relevant person to inform them of the failure detection event. In some examples, the fall protection assembly 222 can be activated (e.g., the detent 402 moved to the extended position) based on other inputs and/or for other reasons independent of a detected belt failure (e.g., by a user seeking to lock the door panel at any desired position).

As discussed above, in some examples, separate belt tension sensing assemblies 200 and separate fall protection assemblies 222 are implemented in both side frame assemblies 102 (e.g., on either side of the door panel 104). In some examples, the fall protection assemblies 222 on a given side of the door panel 104 is triggered by a signal from the belt tension sensing assembly 200 on the same side of the door panel 104. In other examples, both fall protection assemblies 222 (on both sides of the door panel 104) are triggered when at least one belt tension sensing assembly 200 (e.g., on either side of the door panel 104) produces a signal indicating a potential belt failure.

FIG. 14A is a cross-sectional view of another example door system 1400 with another example fall protection assembly 1402 with an example detent 1404 in a retracted position. FIG. 14B is a cross-sectional view of the example door system 1400 of FIG. 14A with the example detent 1404 in an extended position. The same reference numbers used in FIGS. 1A-13 are used for the same or substantially the same features shown in FIGS. 14A and 14B. Further, the description of such features provided above applies similarly to the corresponding features shown in FIGS. 14A and 14B. Thus, as shown in the illustrated example of FIGS. 14A and 14B, the door system 1400 includes the example door panel 104 with panel segments (e.g., solid panels 107 and/or vision panels 111) connected via hinges 110. As shown in this example, the door panel 104 is guided along the track 108 by wheels 116 that roll along the inner channel 224 of the track 108. In some examples, the wheels 116 are connected to the door panel 104 via wheel posts 1406 that are aligned with the hinges 110.

In the illustrated example of FIGS. 14A and 14B, the detent 1404 is a rigid plunger (e.g., a metal shaft or rod) that is pushed into the inner channel 224 of the track 108 (as shown in FIG. 14B) by a spring 1408 that is preloaded in compression when the detent 1404 is in the retracted position (as shown in FIG. 14A). The spring 1408 can be any suitable size and/or strength to push any suitable size of detent 1404. This can provide for greater flexibility, reliability, and/or robustness (e.g., based on using a larger and/or stronger detent 1404 made of any desirable material) than may be possible using the armature of a linear solenoid as the detent as discussed above in connection with FIGS. 10A-13. In some examples, a linear solenoid may still be used to retain the detent 1404 in the retracted position by, for example, the armature extending through a wall of a housing 1410 of the fall protection assembly 1402. In other examples, the detent 1404 can be retained within the housing 1410 until triggered for release in any other suitable manner. In some examples, as shown in FIG. 14B, the detent 1404 extends into the track 108 itself to directly block the door panel 104 from moving. However, in other examples, the detent 1404 can push or otherwise cause any other suitable object (e.g., a latch) to extend into the track 108 to block movement of the door panel 104.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the detection of potential drive belt failures in vertically translating powered doors. Further, examples disclosed herein provide mechanisms to prevent door panels from falling in response to the detection of a drive belt failure.

Further examples and combinations thereof include the following:

Example 1 includes an apparatus comprising a bracket mountable adjacent to a drive belt of a vertically translating door, a roller to be coupled to the bracket in a position to be in contact with the drive belt, the roller to pivot about a first axis relative to the bracket, the roller to rotate about a second axis relative to the bracket as the drive belt moves against the roller, and a sensor to sense movement of the roller about the first axis in response to a loss of tension in the drive belt.

Example 2 includes the apparatus of example 1, including a spring to be coupled to the bracket, the spring to urge the roller into contact with the drive belt.

Example 3 includes the apparatus of any one or more of examples 1-2, wherein the sensor is a proximity sensor.

Example 4 includes the apparatus of any one or more of examples 1-3, wherein the sensor is a photoelectric sensor.

Example 5 includes the apparatus of any one or more of examples 1-4, wherein the sensor is an encoder.

Example 6 includes the apparatus of any one or more of examples 1-5, wherein the sensor is a first sensor, the apparatus including a second sensor, the first sensor to sense a first loss of tension in the drive belt, and the second sensor to sense a second loss of tension in the drive belt, the first loss of tension corresponding to the drive belt loosening without breaking, the second loss of tension corresponding to the drive belt breaking.

Example 7 includes the apparatus of any one or more of examples 1-6, including a door panel, a track to guide movement of the door panel, the drive belt to enable the movement of the door panel, and an extendible detent to extend into the track to block the movement of the door panel.

Example 8 includes the apparatus of example 7, wherein the detent is an armature of a linear solenoid.

Example 9 includes the apparatus of any one or more of examples 7-8, wherein the detent is a metal shaft that is pushed into the track by a compressed spring.

Example 10 includes the apparatus of any one or more of examples 7-9, wherein the detent is to automatically extend into the track in response to the sensor detecting the loss of tension in the drive belt.

Example 11 includes the apparatus of any one or more of examples 1-10, wherein the roller has a length and a diameter, the length greater than the diameter.

Example 12 includes an apparatus comprising a metal bracket, a metal arm coupled to the metal bracket, the metal arm to pivot between a first position and a second position relative to the metal bracket, a spring to urge the metal arm towards the first position, and a sensor to be carried by the bracket, the sensor to detect when the metal arm is in the first position.

Example 13 includes the apparatus of example 12, wherein the metal arm includes a tab that protrudes from a side of the arm, the sensor to sense the tab when the arm is in the first position.

Example 14 includes the apparatus of any one or more of examples 12-13, including an elongate roller supported by the metal arm, the elongate roller to rotate relative to the metal arm, the elongate roller to pivot, with the metal arm, relative to the metal bracket.

Example 15 includes the apparatus of example 14, including a door panel including a plurality of panel segments, a track to guide movement of the door panel, and a drive belt to cause the door panel to move, the spring to urge the roller into contact with the drive belt, contact between the roller and the drive belt to prevent the metal arm from pivoting to the first position when the drive belt is in tension.

Example 16 includes the apparatus of example 15, including a mechanical stop to extend into the track and inhibit movement of the door.

Example 17 includes the apparatus of example 16, wherein the track includes a straight portion along a height of the door and a curved portion, the curved portion above the straight portion, the mechanical stop to extend into the curved portion of the track.

Example 18 includes the apparatus of example 17, wherein the mechanical stop extends into the track in a direction normal to a curve of the curved portion of the track.

Example 19 includes the apparatus of any one or more of examples 16-18, including a door controller, the sensor to provide a signal to the door controller indicating when the metal arm is in the first position, the door controller to cause the mechanical stop to extend into the track based on the signal.

Example 20 includes the apparatus of example 19, wherein the door controller is to transmit a report to a remote server, the report to indicate a belt failure detection event.

Example 21 includes an apparatus comprising a door panel, a track to guide movement of the door panel, a drive belt to enable the movement of the door panel, a sensor to monitor tension in the drive belt, and a mechanical stop to extend into the track to block the movement of the door panel in response to the sensor detecting a loss of tension in the drive belt.

Example 22 includes the apparatus of example 21, wherein the mechanical stop is to be extended into the track by at least one of a solenoid or a spring.

Example 23 includes the apparatus of any one or more of examples 21-22, including a camera to be oriented so that at least a portion of the apparatus is in a field of view of the camera; and a controller to provide event footage corresponding to a video stream captured by the camera at a time associated to when the sensor detected the loss of tension in the drive belt.

Example 24 includes the apparatus of example 23, wherein the camera is to capture the video stream of the at least the portion of the apparatus on an ongoing basis, and the event footage is to include first footage before the sensor detected the loss of tension in the drive belt and second footage after the sensor detected the loss of tension in the drive belt.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a bracket mountable adjacent to a drive belt of a vertically translating door;
a roller to be coupled to the bracket in a position to be in contact with the drive belt, the roller to pivot about a first axis relative to the bracket, the roller to rotate about a second axis relative to the bracket as the drive belt moves against the roller; and
a sensor to sense movement of the roller about the first axis in response to a loss of tension in the drive belt.

2. The apparatus of claim 1, including a spring to be coupled to the bracket, the spring to urge the roller into contact with the drive belt.

3. (canceled)

4. (canceled)

5. (canceled)

6. The apparatus of claim 1, wherein the sensor is a first sensor, the apparatus including a second sensor, the first sensor to sense a first loss of tension in the drive belt, and the second sensor to sense a second loss of tension in the drive belt, the first loss of tension corresponding to the drive belt loosening without breaking, the second loss of tension corresponding to the drive belt breaking.

7. The apparatus of claim 1, including:
a door panel;
a track to guide movement of the door panel;
the drive belt to enable the movement of the door panel; and
an extendible detent to extend into the track to block the movement of the door panel.

8. The apparatus of claim 7, wherein the detent is an armature of a linear solenoid.

9. The apparatus of claim 7, wherein the detent is a metal shaft that is pushed into the track by a compressed spring.

10. The apparatus of claim 7, wherein the detent is to automatically extend into the track in response to the sensor detecting the loss of tension in the drive belt.

11. The apparatus of claim 1, wherein the roller has a length and a diameter, the length greater than the diameter.

12. An apparatus comprising:
a metal bracket;
a metal arm coupled to the metal bracket, the metal arm to pivot between a first position and a second position relative to the metal bracket;
a spring to urge the metal arm towards the first position; and
a sensor to be carried by the bracket, the sensor to detect when the metal arm is in the first position.

13. The apparatus of claim 12, wherein the metal arm includes a tab that protrudes from a side of the arm, the sensor to sense the tab when the arm is in the first position.

14. The apparatus of claim 12, including an elongate roller supported by the metal arm, the elongate roller to rotate relative to the metal arm, the elongate roller to pivot, with the metal arm, relative to the metal bracket.

15. The apparatus of claim 14, including:
a door panel including a plurality of panel segments;
a track to guide movement of the door panel; and
a drive belt to cause the door panel to move, the spring to urge the roller into contact with the drive belt, contact between the roller and the drive belt to prevent the metal arm from pivoting to the first position when the drive belt is in tension.

16. The apparatus of claim 15, including a mechanical stop to extend into the track and inhibit movement of the door.

17. The apparatus of claim 16, wherein the track includes a straight portion along a height of the door and a curved portion, the curved portion above the straight portion, the mechanical stop to extend into the curved portion of the track.

18. (canceled)

19. The apparatus of claim 16, including a door controller, the sensor to provide a signal to the door controller indicating when the metal arm is in the first position, the door controller to cause the mechanical stop to extend into the track based on the signal.

20. The apparatus of claim 19, wherein the door controller is to transmit a report to a remote server, the report to indicate a belt failure detection event.

21. An apparatus comprising:
a door panel;
a track to guide movement of the door panel;
a drive belt to enable the movement of the door panel;
a sensor to monitor tension in the drive belt; and
a mechanical stop to extend into the track to block the movement of the door panel in response to the sensor detecting a loss of tension in the drive belt.

22. The apparatus of claim 21, wherein the mechanical stop is to be extended into the track by at least one of a solenoid or a spring.

23. The apparatus of claim 21, including:
a camera to be oriented so that at least a portion of the apparatus is in a field of view of the camera; and
a controller to provide event footage corresponding to a video stream captured by the camera at a time corresponding to when the sensor detected the loss of tension in the drive belt.

24. The apparatus of claim 23, wherein the camera is to capture the video stream of the at least the portion of the apparatus on an ongoing basis, and the event footage is to include first footage before the sensor detected the loss of tension in the drive belt and second footage after the sensor detected the loss of tension in the drive belt.
